(19) United States
(12) Patent Application Publication
(10) Pub. No.: US 2014/0184521 A1
(43) Pub. Date: Jul. 3, 2014

(54) INTEGRATED CAMERA LENS AND TOUCH SCREEN COVER FOR AN ELECTRONIC DEVICE

(71) Applicants: Wah Yiu Y.U. Kwong, Beaverton, OR (US); Hong Wong, Portland, OR (US)

(72) Inventors: Wah Yiu Y.U. Kwong, Beaverton, OR (US); Hong Wong, Portland, OR (US)

(21) Appl. No.: 13/730,350

(22) Filed: Dec. 28, 2012

(51) Int. Cl. G03B 17/12; G06F 3/041

(52) U.S. Cl. CPC G03B 17/12; G06F 3/0412
USPC 345/173; 396/529

(57) ABSTRACT

Particular embodiments described herein provide a touch screen assembly for an electronic device, such as a laptop, notebook or tablet, having a camera module. The touch screen assembly includes a touch screen cover having a touch sensor layer extending across a portion of a surface of the touch screen cover, and a camera lens element integrated with the touch screen cover. The camera lens element is configured to be held at a predetermined distance with respect to the camera module of the electronic device.

### TECHNICAL FIELD

Embodiments described herein generally relate to an integrated camera lens and touch screen cover for an electronic device.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified cross-sectional diagram illustrating an embodiment of an integrated camera lens and touch screen cover assembly for an electronic device;

FIG. 1B is a simplified front view of integrated camera lens and touch screen cover assembly of FIG. 1A;

FIG. 2 is a simplified diagram illustrating a perspective front view of an embodiment of an electronic device including the integrated camera lens and touch screen cover assembly of FIGS. 1A-1B

FIG. 3 is a simplified diagram illustrating an perspective front view of another embodiment of an electronic device including the integrated camera lens and touch screen cover assembly 100 of FIGS. 1A-1B;

FIG. 4 is a simplified block diagram of another embodiment of an electronic device including integrated camera lens and touch screen cover assembly of FIGS. 1A-1B; and

FIG. 5 is a flow diagram illustrating an example operation of electronic device including the integrated camera lens and touch screen cover assembly of FIGS. 1A-1B.

### DETAILED DESCRIPTION OF EXAMPLE EMBODIMENTS

The following detailed description sets forth example embodiments of apparatuses, methods, and systems relating to integrated camera lens and touch screen cover configurations for an electronic device. Features such as structure(s), function(s), and/or characteristic(s), for example, are described with reference to one embodiment as a matter of convenience; various embodiments may be implemented with any suitable one or more of the described features.

Traditional touch screen electronic devices (e.g., laptops, notebook computers, etc.) follow design considerations in which a camera assembly including a camera assembly housing, a camera sensor, and a lens is generally positioned in a housing of the electronic device below a touch cover glass of a touch screen. The thickness of touch screens and display screens are continually being reduced, for example, less than 3 mm, approaching 2 mm or less. However, the thickness of the camera assembly remains a bottleneck in the desire to reduce the overall dimensions of electronic devices. A significant contributor to the thickness requirements of the camera assembly arises due to the thickness of the camera lens housing itself as well as the field of view requirements of the electronic device. Because a larger field of view requires a longer distance and larger lens between the camera sensor and the lens, it is difficult to reduce the space consumed by the camera assembly and lens within an electronic device and still maintain an acceptable field of view if it is desired to produce an electronic device having a reduced thickness. For example, in particular instances an acceptable field of view may be between 75 degrees and 85 degrees which would typically require a camera assembly and associated lens thickness which is greater than 3 mm.

Particular embodiments described herein provide for a touch screen assembly for an electronic device having a camera module, such as a laptop, notebook or tablet. The touch screen assembly includes a touch screen cover having a touch sensor layer extending across a portion of a surface of the touch screen cover, and a camera lens element integrated with the touch screen cover. The camera lens element is configured to be held at a predetermined distance with respect to the camera module of the electronic device.

In more particular embodiments, the camera lens element is configured to receive an object image and focus the object image upon a sensor of the camera module. In other particular embodiments, the touch sensor layer extends across a portion of the touch screen cover. In still more particular embodiments, the camera lens element is integrally formed within a portion of the touch screen cover. In other particular embodiments, the camera lens element is formed separately from the touch screen cover. In other particular embodiments, the camera lens element is disposed within a void of the touch screen cover. In other particular embodiments, the camera lens element is disposed upon a surface of the touch screen cover.

In more particular embodiments, the camera lens element includes at least one substantially convex surface. In still more particular embodiments, the camera lens element is substantially circular in shape with respect to a plane of the surface of the touch screen cover. In still other particular embodiments, the touch screen assembly further includes a display screen disposed under a portion of the touch screen cover.

Other particular embodiments described herein provide for an electronic device include a camera module including a sensor, a touch screen cover having a touch sensor layer extending across a portion of a surface of the touch screen cover, and a camera lens element integrated with the touch screen cover. The camera lens element is configured to be held at a predetermined distance with respect to the sensor of the camera module.

### Integrated Camera Lens and Touch Screen Cover for an Electronic Device

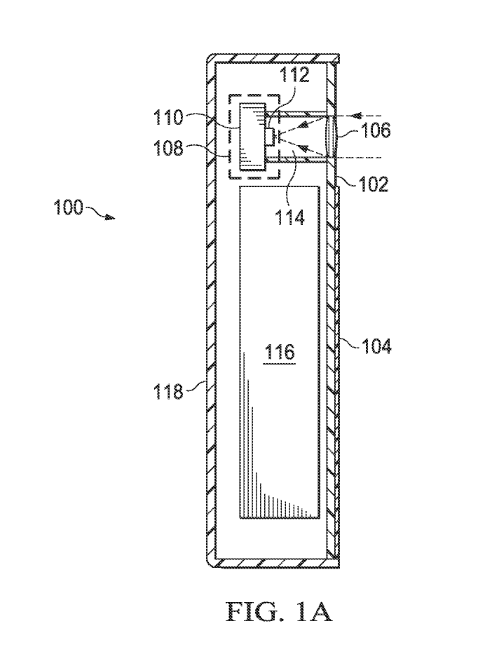

FIG. 1A is a simplified cross-sectional diagram illustrating an embodiment of an integrated camera lens and touch screen cover assembly 100 for an electronic device. FIG. 1B is a simplified front view of integrated camera lens and touch screen cover assembly 100 of FIG. 1A. In various embodiments, the electronic device may include any electronic device configured to include image capture and/or camera functionality combined with touch screen functionality such as a smartphone, tablet, desktop computer, laptop computer, netbook, or ultrabook. Integrated camera lens and touch screen cover assembly 100 includes touch screen cover 102 having a touch sensor layer 104 disposed upon a portion of an upper surface of touch screen cover 102. Touch screen cover 102 includes a camera lens element 106 integrally formed within a portion of touch screen cover 102. Integrated camera lens and touch screen cover assembly 100 further includes a camera module 108 having a camera module housing 110, and a camera sensor 112. Integrated camera lens and touch screen cover assembly 100 further includes a lens barrel 114 having a first end coupled to camera module 108 and a second end coupled to camera lens element 106. In one or more embodiments, lens barrel 114 extends a predetermined length or distance between camera module 108 and camera lens element 106. Although the embodiment illustrated in FIG. 1A shows lens barrel 114 as being separate from camera module 108, in other embodiments, lens barrel 114 may be integrated with camera module 108. Integrated camera lens and touch screen cover assembly 100 further includes a display screen 116 disposed under a portion of touch screen cover 102 and touch sensor layer 104. Integrated camera lens and touch screen cover assembly 100 further includes a device housing 118 having camera module 108 and display screen 116 disposed therein.

Touch screen cover 102 is constructed of a transparent or semi-transparent material and configured to support user interaction with touch sensor layer 104. In at least one embodiment, touch sensor layer 104 is configured to detect a user touch and/or detect a user placing a finger in close proximity to touch sensor layer 104 to allow the user to interact with touch sensor layer 104. In at least one embodiment, the user interaction may be in response to images displayed on a portion of display screen 116 underlying touch sensor layer 104. In the particular embodiment illustrated in FIGS. 1A-1B, touch sensor layer 104 extends substantially across the portion of touch screen cover 102 overlying display screen 116. Touch sensor layer 104 may use capacitive, resistive, surface acoustic wave, or any other suitable touch screen technology to detect user interaction with touch sensor layer 104. Touch screen cover 102 is further configured to provide protection for components within device housing 118 such as display screen 116 and camera module 108. In a particular embodiment, touch screen cover 102 is constructed of a glass substrate material. In still other embodiments, touch screen cover 102 may be constructed of plastic or any other suitable material. Touch sensor layer 104 is configured to receive a user touch input for interaction with an image or object displayed by display screen 116.

Camera lens element 106 is configured to function as a focus lens for camera module 108, and in at least one embodiment camera lens element 106 is positioned at a predetermined distance from camera sensor 112 such that a focal point of camera lens element 106 is located upon the surface of camera sensor 112. In a particular embodiment, camera lens element 106 is substantially circular in shape with respect to a plane of a surface of touch screen cover 102. Camera module 108 is configured to capture one or more images received by camera sensor 112 passing through and focused by camera lens element 106. In a particular embodiments, camera sensor 112 is a charge-coupled device (CCD) sensor. In still other embodiments, camera sensor 112 may be any other suitable image capture device. In various embodiments, the captured images may be processed by one or more processors, stored within a memory and/or displayed by display screen 116. In one or more embodiments, camera lens element 106 is integrally formed within touch screen cover 102. In still other embodiment, camera lens element 106 may be constructed and/or formed separately from touch screen cover 102 and positioned and/or disposed within a void of touch screen cover 102. In still other embodiments, camera lens element 106 may be disposed upon the upper surface and/or lower surface of touch screen cover 102. In at least one embodiment, at least a portion of camera lens element 106 is constructed of a transparent or semi-transparent material. In a particular embodiment, camera lens element 106 is constructed of the same material as that of touch screen cover 102.

Although the particular camera lens element 106 is illustrated as having a upper and lower substantially convex surface, it should be understood that in other embodiments camera lens element 106 may be configured to be of any desired a size and/or shape so as to function to collect light from an object or objects to form an image and provide the image to camera sensor 112 of camera module 108 so that the image may be captured by camera module 108. In various embodiments, the captured image may be stored and/or viewed by the electronic device. In a particular embodiment, camera lens element 106 may function to magnify an image received by camera lens element 106. In still other embodiments, camera lens element 106 may be constructed for any suitable lens configuration to provide any other desired transformation of an image received from an object or objects such as magnification, macro, zoom, fish-eye, and/or filtering of the image. In addition, although the illustrated embodiments are shown as using a single camera lens element 106, in other embodiments multiple lenses may be used.

In at least one embodiment, lens barrel 114 of camera module 108 is configured to shield camera sensor 112 from extraneous light such that substantially only the light passing through camera lens element 106 is received by camera sensor 112. In the illustrated embodiment, lens barrel 114 is of a substantially hollow cylindrical shape extending from camera module housing 110 to touch screen cover 102. In other embodiments, lens barrel 114 may be of any desired size and/or shape to shield camera sensor 112 from extraneous light. In still other embodiments, lens barrel 114 may be omitted.

Display screen 116 is configured to display one or more images, such as an image captured by camera module 108. In one or more embodiments, display screen 116 is a screen that can be a liquid crystal display (LCD) display screen, a light-emitting diode (LED) display screen, an organic light-emitting diode (OLED) display screen, a plasma display screen, or any other suitable display screen system.

Device housing 118 is configured to contain and protect various components of integrated camera lens and touch screen cover assembly 100 such as camera module 108 and display screen 116. Device housing 118 is further configured to support touch screen cover 102 and camera lens element 106 at a predetermined distance from camera module 108 and/or display screen 116.

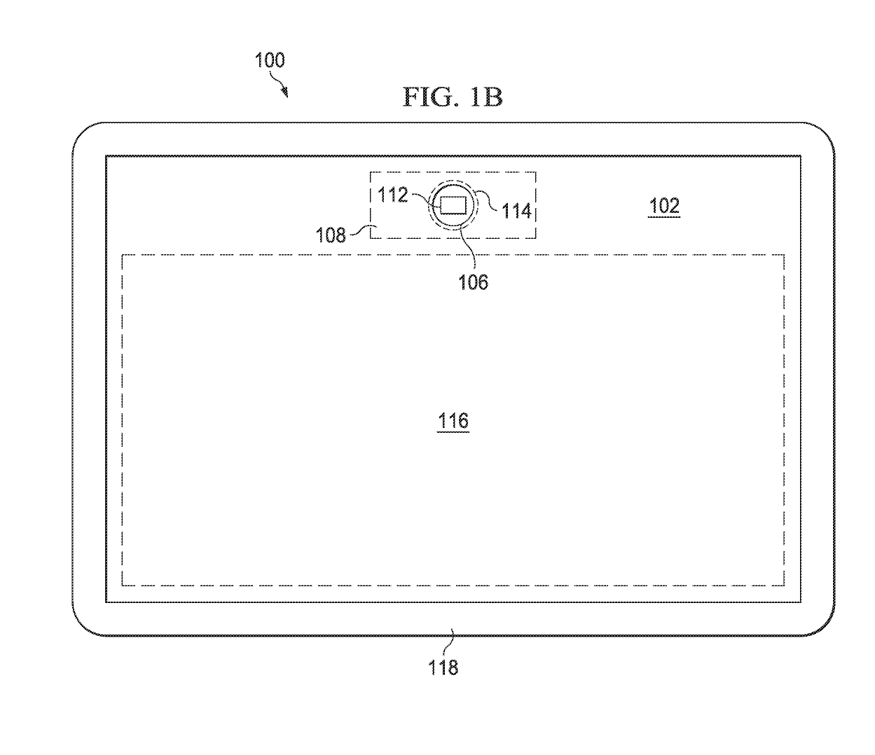

FIG. 2 is a is a simplified diagram illustrating a perspective front view of an embodiment of an electronic device 200 including integrated camera lens and touch screen cover assembly 100 of FIGS. 1A-1B. In the embodiment illustrated in FIG. 2, electronic device 200 comprises a laptop computer shown in an open configuration. The electronic device 200 includes a lower housing 202 and an upper housing 204 coupled together via a hinge(s) 206. Hinge 206 enables electronic device 200 to be positioned between an open configuration and a closed configuration. A keyboard 208 and touchpad 210 are disposed upon or within lower housing 202, and a display screen disposed upon or within upper housing 204. Upper housing 204 further includes touch screen cover 102 having integrated camera lens element 106 disposed above display screen 116. Touch sensor layer 104 is disposed upon a portion of the surface of touch screen cover 102 to enable touch interaction by a user. Electronic device 200 further includes camera module 108 disposed within upper housing 204 and positioned such that the focal point of integrated camera lens element 106 falls upon camera sensor 112 of camera module 108. In the particular embodiment illustrated in FIG. 2, camera module 108, lens barrel 114, and integrated camera lens element 106 of touch screen cover 102 may function as a webcam for a user of electronic device 200.

As described with respect to other embodiments, electronic device 200 may be configured to capture an image of an object focused by camera lens element 106 using camera module 108 and display the captured image on display screen 116. In one or more embodiments, the user of electronic device 200 may use one or more of touch sensor layer 104, keyboard 208 or the touchpad 210 to control various aspects regarding the capturing, storing, and display of a captured image.

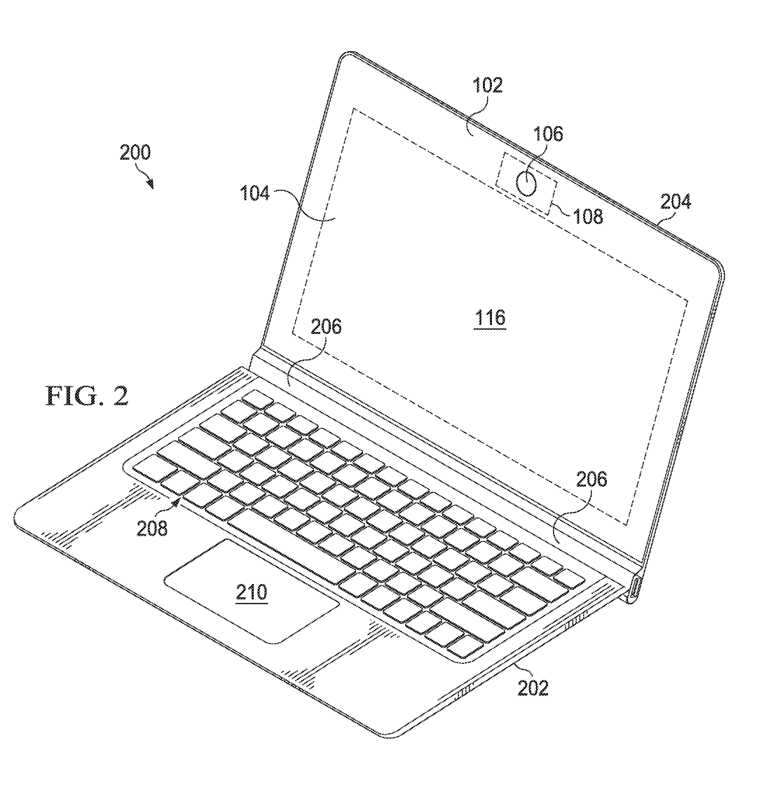

FIG. 3 is a is a simplified diagram illustrating a perspective front view of another embodiment of an electronic device 300 including integrated camera lens and touch screen cover assembly 100 of FIGS. 1A-1B. In the embodiment illustrated in FIG. 3, electronic device 300 comprises a tablet device having a rear-facing camera. As illustrated in FIG. 3, electronic device 300 further includes a housing portion 302. In the particular embodiment illustrated in FIG. 3, housing portion 302 includes touch screen cover 102 having touch sensor layer 104 disposed upon and/or extending across a portion of a surface thereof. Touch screen cover 102 further includes integrated camera lens element 106. Electronic device 300 further includes camera module 108 disposed within housing portion 302 and positioned such that the focal point of camera lens element 106 falls upon camera sensor 112 of camera module 108. In the particular embodiment illustrated in FIG. 3, camera module 108 and integrated camera lens element 106 of touch screen cover 102 may function as a rear-facing camera for a user of electronic device 300. Electronic device 300 may further include a user interface 304 to allow further user interaction with electronic device 300. In a particular embodiment, user interface 304 may include one or more buttons or soft buttons.

As described with respect to other embodiments, electronic device 300 may be configured to capture an image of an object focused by camera lens element 106 using camera module 108 and display the captured image on display screen 116. In one or more embodiments, the user of electronic device 300 may use one or more of touch sensor layer 104 or user interface 304 to control various aspects regarding the capturing, storing, and display of a captured image.

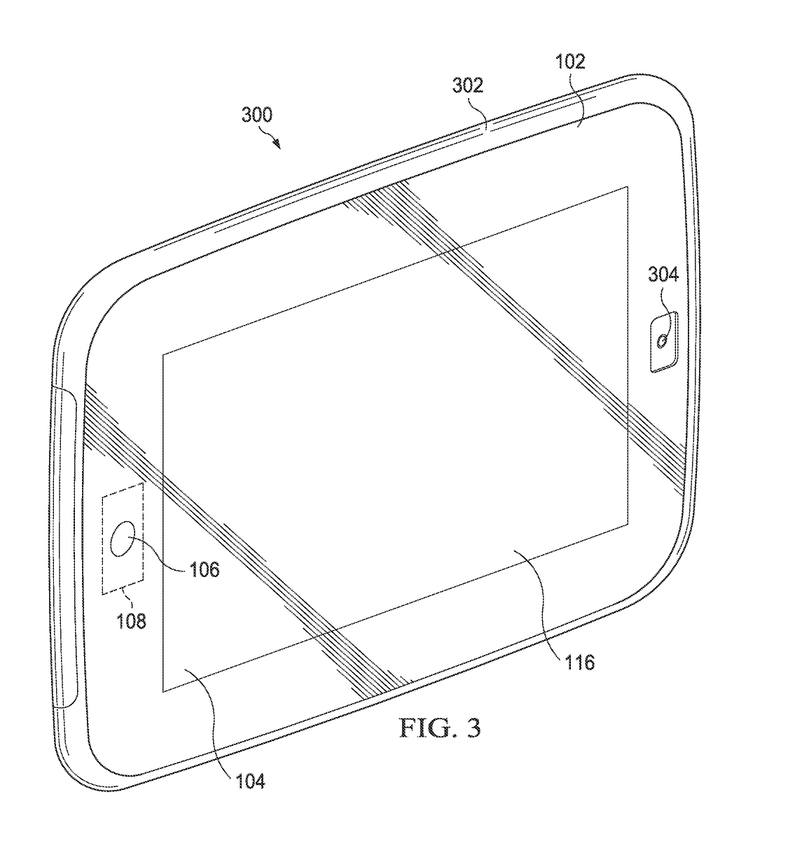

FIG. 4 is a simplified block diagram of another embodiment of an electronic device 400 including integrated camera lens and touch screen cover assembly 100 of FIGS. 1A-1B. In various embodiments, electronic device 400 may include one or more of electronic device 200 or electronic device 300 as previously described herein. Electronic device 400 includes one or more processors 802, a memory element 804, camera module 108, touch screen cover 102 with integrated camera lens element 106, user interface module 406, touch sensor 104, display screen 116, application module 408, and storage device 410. Processor(s) 402 is configured to execute various tasks of electronic device 400 as described herein and memory element 404 is configured to store data associated with electronic device 400. Camera module 108 is configured to capture one or more images received by camera lens element 106 of touch screen cover 102. Camera lens element 106 is held within a predetermined alignment and distance with respect to camera sensor 112 of camera module 108 via the touch screen cover 102. Touch sensor 104 is configured and user interface module 406 is configured to provide a user interface to a user of electronic device 400 such as allowing a user to initiate an image capture operation, store a captured image, view a captured image, or interact with an image or objects displayed by display screen 118. In various embodiments, user interface module 406 may include one or more of a keyboard, one or more buttons, a touch screen, a touchpad or any other suitable user interface device. Display screen 118 may be configured to display a captured image as received by integrated camera lens element 106 as well as provide other visual feedback to a user of electronic device 400. In various embodiments, display screen 118 may include one or more of a liquid crystal display (LCD) device, a light emitting diode (LED) display device, an organic light emitting diode (OLED) display device, or any other suitable display device.

Application module 408 includes one or more software applications configured to control various aspects of electronic device 400. For example, application module 408 may include one or more software applications configured to control camera module 108, touch sensor 104, user interface module 406, display screen 116, and/or storage device 410. In particular embodiments, application module 408 may include one or more software applications configured to allow a user to manually control capture of an image by camera module 108, display of a captured image by display screen 116, storage of a captured image within storage device 410 and/or retrieval of a stored captured image from storage device 410. Storage device 410 is configured to store data associated with electronic device 400 including captured images, user data, and any other data. In various embodiments storage device 400 may include one or more of a removable storage device, disc-based storage device, solid-state storage device or any other suitable storage device.

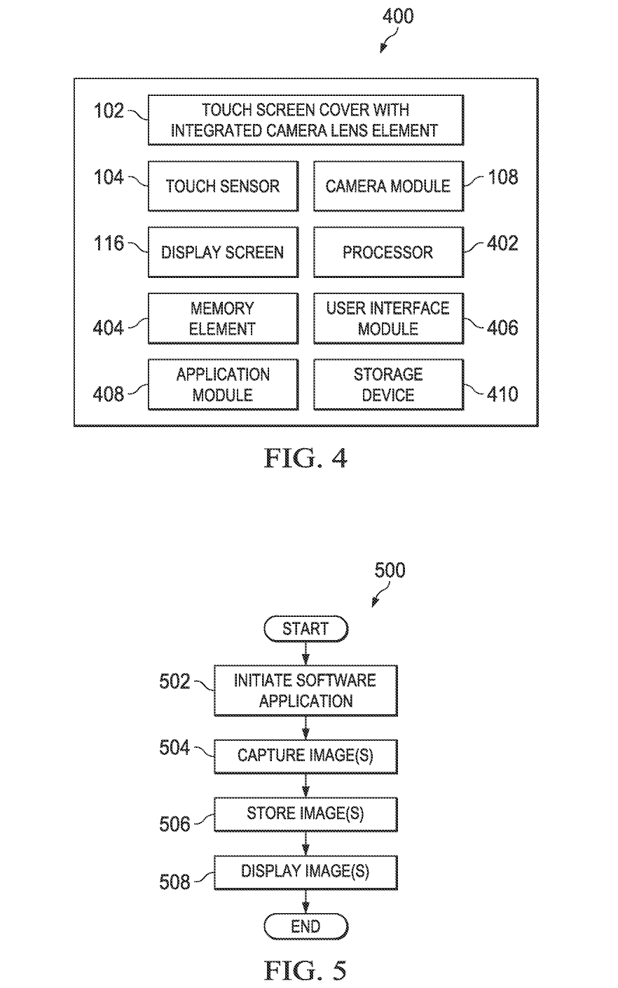

FIG. 5 is a flow diagram 500 illustrating an example operation of electronic device 400 including integrated camera lens and touch screen cover assembly 100 of FIGS. 1A-1B. In 502, a software application for capturing images using camera module 108 is initiated. In 504, one or more images is captured by camera module 108. The capture image(s) is obtained from an object image received by camera lens element 106 integrated with touch screen cover 102 and provided to camera sensor 112 of camera module 108. In some embodiments, camera lens element 106 may be configured to perform an image transformation upon the object image before providing the object image to camera sensor 112. In particular embodiments, the camera lens element 106 may perform one or more of any desired image transformation to the object image received from an object such as magnification, macro, zoom, fish-eye, and/or filtering of the object image before directing the transformed object image to camera module 108. In 506, the captured image(s) may be stored within storage device 410. In 508, the stored image(s) may be viewed by a user of electronic device 400 within display screen 116.

Some embodiments may provide for one or more advantages such as reducing the thickness required for a camera module and associated lens to allow electronic devices having a thinner profile than would otherwise be possible when incorporated with camera capabilities. Other embodiments may provide for an advantage of improving camera clarity and quality of an electronic device while still maintaining a thin profile.

It is imperative to note that all of the specifications, dimensions, and relationships outlined herein (e.g., height, width, length, materials, etc.) have only been offered for purposes of example and teaching only. Each of these data may be varied considerably without departing from the spirit of the present disclosure, or the scope of the appended claims. Any suitable length, width, and depth (or height) may be used and can be based on particular end user needs, or specific elements to be addressed by the apparatus (or the system in which it resides). The specifications apply only to one non-limiting example and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Example Embodiment Implementations

One particular example implementation may include a touch screen assembly for an electronic device having a camera module, such as a laptop, notebook or tablet. The touch screen assembly includes a touch screen cover having a touch sensor layer extending across a portion of a surface of the touch screen cover, and a camera lens element integrated with the touch screen cover. The camera lens element is configured to be held at a predetermined distance with respect to the camera module of the electronic device.

In another particular example, the camera lens element is configured to receive an object image and focus the object image upon a sensor of the camera module. In another particular example, the touch sensor layer extends across a portion of the touch screen cover. In another particular example, the camera lens element is integrally formed within a portion of the touch screen cover. In another particular example, the camera lens element is formed separately from the touch screen cover. In another particular example, the camera lens element is disposed within a void of the touch screen cover. In another particular example, the camera lens element is disposed upon a surface of the touch screen cover.

In another particular example, the camera lens element includes at least one substantially convex surface. In another particular example, the camera lens element is substantially circular in shape with respect to a plane of the surface of the touch screen cover. In another particular example, the touch screen assembly further includes a display screen disposed under a portion of the touch screen cover.

In another particular example, the touch screen assembly further includes a lens barrel having a first end coupled to the camera module and a second end coupled to the camera lens element, the lens barrel extending the predetermined distance between camera module and camera lens element.

Another particular example implementation may include an electronic device including a camera module having a sensor, a touch screen cover having a touch sensor layer extending across a portion of a surface of the touch screen cover, and a camera lens element integrated with the touch screen cover. The camera lens element is configured to be held at a predetermined distance with respect to the sensor of the camera module.

What is claimed is:

1. A touch screen assembly for an electronic device including a camera module, comprising:
a touch screen cover having a touch sensor layer extending across a portion of a surface of the touch screen cover; and
a camera lens element integrated with the touch screen cover, wherein the camera lens element is configured to be held at a predetermined distance with respect to the camera module of the electronic device.

2. The touch screen assembly of claim 1, wherein the camera lens element is configured to receive an object image and focus the object image upon a sensor of the camera module.

3. The touch screen assembly of claim 1, wherein the touch sensor layer extends across a portion of the touch screen cover.

4. The touch screen assembly of claim 1, wherein the camera lens element is integrally formed within a portion of the touch screen cover.

5. The touch screen assembly of claim 1, wherein the camera lens element is formed separately from the touch screen cover.

6. The touch screen assembly of claim 1, wherein the camera lens element is disposed within a void of the touch screen cover.

7. The touch screen assembly of claim 1, wherein the camera lens element is disposed upon a surface of the touch screen cover.

8. The touch screen assembly of claim 1, wherein the camera lens element includes at least one substantially convex surface.

9. The touch screen assembly of claim 1, wherein the camera lens element is substantially circular in shape with respect to a plane of the surface of the touch screen cover.

10. The touch screen assembly of claim 1, further comprising a display screen disposed under a portion of the touch screen cover.

11. The touch screen assembly of claim 1, further comprising a lens barrel having a first end coupled to the camera module and a second end coupled to the camera lens element, the lens barrel extending the predetermined distance between camera module and camera lens element.

12. An electronic device, comprising:
a camera module including a sensor;
a touch screen cover having a touch sensor layer extending across a portion of a surface of the touch screen cover; and
a camera lens element integrated with the touch screen cover, wherein the camera lens element is configured to be held at a predetermined distance with respect to the sensor of the camera module.

13. The electronic device of claim 12, wherein the camera lens element is configured to receive an object image and focus the object image upon the sensor of the camera module.

14. The electronic device of claim 12, wherein the touch sensor layer extends across a portion of the touch screen cover.

15. The electronic device of claim 12, wherein the camera lens element is integrally formed within a portion of the touch screen cover.

16. The electronic device of claim 12, wherein the camera lens element is formed separately from the touch screen cover.

17. The electronic device of claim 12, wherein the camera lens element is disposed within a void of the touch screen cover.

18. The electronic device of claim 12, wherein the camera lens element is disposed upon a surface of the touch screen cover.

19. The electronic device of claim 12, wherein the camera lens element includes at least one substantially convex surface.

20. The electronic device of claim 12, wherein the camera lens element is substantially circular in shape with respect to a plane of the surface of the touch screen cover.

21. The electronic device of claim 12, further comprising a display screen disposed under a portion of the touch screen cover.

22. The electronic device of claim 12, further comprising a housing, wherein the camera module is disposed within the housing.

23. The electronic device of claim 12, further comprising a lens barrel having a first end coupled to the camera module and a second end coupled to the camera lens element, the lens barrel extending the predetermined distance between camera module and camera lens element.
